(19) United States
(12) Patent Application Publication
(10) Pub. No.: US 2026/0268619 A1
(43) Pub. Date: Sep. 10, 2026

(54) SYSTEMS AND METHODS FOR RECOGNIZING OBJECTS IN 3D REPRESENTATIONS OF SPACES

(71) Applicant: INTERAPTIX INC., Toronto (CA)

(72) Inventors: Dae Hyun LEE, Etobicoke (CA); Parya JAFARI, Toronto (CA)

(21) Appl. No.: 18/876,189

(22) PCT Filed: Sep. 28, 2023
(86) PCT No.: PCT/IB2023/059689

§ 371 Date: Dec. 17, 2024

Related U.S. Application Data
(60) Provisional application No. 63/412,077, filed on Sep. 30, 2022.

(51) Int. Cl. G06T 19/20; G06V 20/40; G06V 20/64

(52) U.S. Cl. CPC G06T 19/20; G06V 20/46; G06V 20/64; G06T 2219/2021

(57) ABSTRACT

An example method includes: obtaining, from an object detection engine trained to recognize a plurality of objects, an image representing a space and including an object of interest located in the space and a location of the object of interest within the image; converting, based on the location of the object within the image, a source location of an image capture device which captured the image and a three-dimensional representation, the location of the object to a three-dimensional location of the object within the three-dimensional representation of the space; and updating the three-dimensional representation of the space to include an indication of the three-dimensional location of the object of interest.

### CROSS-REFERENCE TO RELATED APPLICATION(S)

This application claims the benefit of U.S. Provisional Patent Application No. 63/412,077, filed Sep. 30, 2022, entitled “SYSTEMS AND METHODS FOR RECOGNIZING OBJECTS IN 3D REPRESENTATIONS OF SPACES”; the entire contents of which are incorporated herein by reference.

### FIELD

The specification relates generally to systems and methods for virtual representations of spaces, and more particularly to a system and method for recognizing objects in a 3D representation of a space.

### BACKGROUND

Virtual representations of spaces may be captured using data capture devices to capture image data, depth data, and other relevant data to allow the representation to be generated. It may be beneficial to automatically recognize objects, such as hazards, in the representations, for example to facilitate inspections or other regular reviews of the space. However, many object recognition methods are optimized for two-dimensional images rather than three-dimensional representations.

### SUMMARY

According to an aspect of the present specification an example method includes: obtaining, from an object detection engine trained to recognize a plurality of objects, an image representing a space and including an object of interest located in the space and a location of the object of interest within the image; converting, based on the location of the object within the image, a source location of an image capture device which captured the image and a three-dimensional representation, the location of the object to a three-dimensional location of the object within the three-dimensional representation of the space; and updating the three-dimensional representation of the space to include an indication of the three-dimensional location of the object of interest.

According to another aspect of the present specification, an example server includes: a memory storing a three-dimensional representation of a space; a communications interface; and a processor interconnected with the memory and the communications interface, the processor configured to: obtain, from an object detection engine trained to recognize a plurality of objects, an image representing the space and including an object of interest located in the space and a location of the object of interest within the image; convert, based on the location of the object within the image, a source location of an image capture device which captured the image and the three-dimensional representation, the location of the object to a three-dimensional location of the object within the three-dimensional representation of the space; and update the three-dimensional representation of the space to include an indication of the three-dimensional location of the object of interest.

### BRIEF DESCRIPTION OF DRAWINGS

Implementations are described with reference to the following figures, in which:

FIG. 1 depicts a block diagram of an example system for recognizing objects in a three-dimensional representation of a space.

FIG. 2 depicts a flowchart of an example method of recognizing objects in a three-dimensional representation of a space.

FIG. 3 depicts a flowchart of an example method of converting a location in an image to a three-dimensional location in a three-dimensional representation at block 225 of the method of FIG. 2.

FIGS. 4A-4C are schematic diagrams of the performance of the method of FIG. 3.

FIG. 5 is a schematic diagram of another example method of converting a location in an image to a three-dimensional location in a three-dimensional representation at block 225 of the method of FIG. 2.

FIG. 6 is a schematic diagram of an example current capture view at block 230 of the method of FIG. 2.

FIG. 7 is a flowchart of an example method of training an object detection engine in the system of FIG. 1.

### DETAILED DESCRIPTION

Many object recognition methods are optimized for two-dimensional images rather than three-dimensional representations, and hence identifying objects in three-dimensional space may be difficult and time-consuming, particularly since there may be many more degrees of freedom and hence information to analyze.

Accordingly, in the present example, a system leverages two-dimensional object recognition in two-dimensional images, as well as the infrastructure by which a three-dimensional representation is captured, to recognize and locate objects of interest in three-dimensional space.

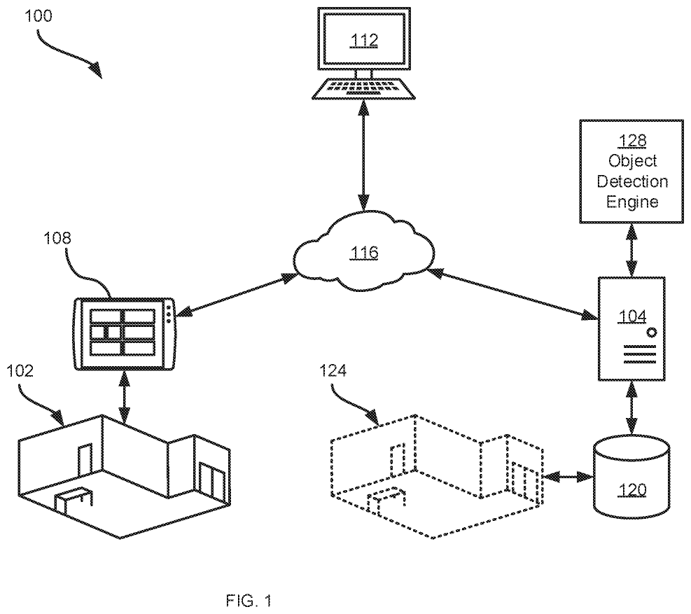

FIG. 1 depicts a block diagram of an example system 100 for recognizing objects in a three-dimensional (3D) representation of a space 102. For example, space 102 can be a factory or other industrial facility, an office a new building, a private residence, or the like. In other examples, the space 102 can be a scene including any real-world location or object, such as a construction site, a vehicle such as ship, equipment, or the like. It will be understood that space 102 as used herein may refer to any such scene, object, target, or the like. System 100 includes a server 104 and a client device 112 which are preferably in communication via a network 116. System 100 additionally includes a data capture device 108 which can also be in communication with at least server 104 via network 116.

Server 104 is generally configured to manage a representation of space 102 and to recognize and identify objects within the representation of space 102. In particular, server 104 may recognize hazards to flag as potential safety issues, for example facilitate an inspection of space 102. Server 104 can be any suitable server or computing environment, including a cloud-based server, a series of cooperating servers, and the like. For example, server 104 can be a personal computer running a Linux operating system, an instance of a Microsoft Azure virtual machine, etc. In particular, server 104 includes a processor and a memory storing machine-readable instructions which, when executed, cause server 104 to recognize objects, such as hazards, within a 3D representation of space 102, as described herein. Server 104 can also include a suitable communications interface (e.g., including transmitters, receivers, network interface devices and the like) to communicate with other computing devices, such as client device 112 via network 116.

Data capture device 108 is a device capable of capturing relevant data such as image data, depth data, audio data, other sensor data, combinations of the above and the like. Data capture device 108 can therefore include components capable of capturing said data, such as one or more imaging devices (e.g., optical cameras), distancing devices (e.g., LIDAR devices or multiple cameras which cooperate to allow for stereoscopic imaging), microphones, and the like. For example, data capture device 108 can be an IPad Pro, manufactured by Apple, which includes a LIDAR system and cameras, a head-mounted augmented reality system, such as a Microsoft Hololens™, a camera-equipped handheld device such as a smartphone or tablet, a computing device with interconnected imaging and distancing devices (e.g., an optical camera and a LIDAR device), or the like. Data capture device 108 can implement simultaneous localization and mapping (SLAM), 3D reconstruction methods, photogrammetry, and the like. That is, during data capture operations, data capture device 108 may localize itself with respect to space 102 and track its location within space 102. The actual configuration of data capture device 108 is not particularly limited, and a variety of other possible configurations will be apparent to those of skill in the art in view of the discussion below.

Data capture device 108 additionally includes a processor, a non-transitory machine-readable storage medium, such as a memory, storing machine-readable instructions which, when executed by the processor, can cause data capture device 108 to perform data capture operations. Data capture device 108 can also include a display, such as an LCD (liquid crystal display), an LED (light-emitting diode) display, a heads-up display, or the like to present a usual with visual indicators to facilitate the data capture operation. Data capture device 108 also includes a suitable communications interface to communicate with other computing devices, such as server 104 via network 116.

Client device 112 is generally configured to present a representation of space 102 to a user and allow the user to interact with the representation, including providing inputs and the like, as described herein. Client device 112 can be a computing device, such as a laptop computer, a desktop computer, a tablet, a mobile phone, a kiosk, or the like. Client device 112 includes a processor and a memory, as well as a suitable communications interface to communicate with other computing devices, such as server 104 via network 116. Client device 112 further includes one or more output devices, such as a display, a speaker, and the like, to provide output to the user, as well as one or more input devices, such as a keyboard, a mouse, a touch-sensitive display, and the like, to allow input from the user. In some examples, client device 112 may be configured to recognize and identify objects in space 102, as described further herein.

Network 116 can be any suitable network including wired or wireless networks, including wide-area networks, such as the Internet, mobile networks, local area networks, employing routers, switches, wireless access points, combinations of the above, and the like.

System 100 further includes a database 120 associated with server 104. For example, database can be one or more instances of My SQL or any other suitable database. Database 120 is configured to store data to be used to identify objects in space 102. In particular, database 120 is configured to store a persistent representation 124 of space 102. In particular, representation 124 may be a 3D representation which tracks persistent spatial information of space 102 over time. For example, representation 124 may be used by server 104 and/or data capture device 108 to assist with localization of data capture device 108 within space 102 and its location tracking during data capture operations. Other representations, including 2D representations (e.g., optical images, thermal images, etc.), 3D representations (e.g., 3D scans, including partial scans, depth maps, etc.), and intermediary data for algorithms (including machine learning) may also be stored at database 120. Database 120 can be integrated with server 104 (i.e., stored at server 104), or database 120 can be stored separately from server 104 and accessed by the server 104 via network 116.

System 100 further includes an object detection engine 128 associated with server 104. Object detection engine 128 is configured to receive an image representing a portion of a space (such as space 102) and identify one or more objects represented in the image. In particular, object detection engine 128 may recognize a plurality of hazards, such as exposed screws, nails, or other building materials, tools (e.g., hammers, saws, etc.), containers of flammable substances, and other potential hazards that may exist in a space. In still further examples, object detection engine 128 may recognize hazards which may vary, such as a large object obstructing a doorway, for example by recognizing a doorway and an object in front of said doorway, without requiring recognition of a specific type, shape, or size of the obstructing object.

For example, object detection engine 128 may employ one or more neural networks, machine learning, or other artificial intelligence algorithms, including any combination of computer vision and/or image processing algorithms to identify such hazards in an image. For example, object detection engine 128 may perform various pre-processing, feature extraction, post-processing, and other suitable image processing to assist with detection of the hazards or objects. In such examples, object detection engine 128 may be trained to recognize hazards or other objects of interest based on annotated input data. For example, object detection engine 128 may be provided with a set of annotated images including an indication of an object for recognition and a label associated with the object. The annotated images may preferably include images of the object at various distances, angles, lighting conditions, and the like. Object detection engine 128 may be provided with a set of such annotated images for each object or hazard desired for recognition.

Object detection engine 128 may output an annotation of the image including an indication of the locations of any recognized hazards (or other objects) within the image. In some examples, the annotated image may include a bounding box or similar indicating a region in which the object is contained in the image. In other examples, the annotated image may include an arbitrarily-shaped outline of the location of the object on the image as a result of semantic segmentation by object detection engine 128. Object detection engine 128 may be integrated with server 104 (i.e., implemented via execution of a plurality of machine-readable instructions by a processor at server 104), or object detection engine 128 may be implemented separately from server 104 (e.g., implemented on another server independent of server 104 via execution of a plurality of machine-readable instructions by a processor at the independent object detection server) and accessed by the server 104 via network 116.

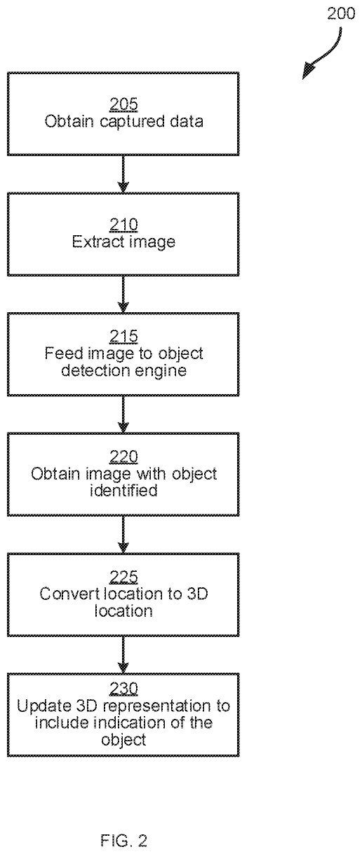

Referring to FIG. 2, an example method 200 of recognizing objects in a 3D representation of space 102 is depicted. Method 200 is described below in conjunction with its performance by server 104, however in other examples, method 200 may be performed by other suitable devices or systems. In some examples, functionality described in relation to client device 112 may be performed by data capture device 108 and vice versa.

Additionally, in some examples, some of the blocks of method 200 can be performed in an order other than that illustrated, and hence are referred to as blocks and not steps.

At block 205, server 104 obtains captured data representing space 102. For example, server 104 may receive the captured data from data capture device 108. The captured data may include image data (e.g., still images and/or video data) and depth data, as well as other data, such as audio data or similar. The captured data may additionally include annotations of features in space 102, such as annotations indicating hazards or objects of interest, for example as provided by the user operating data capture device 108. For example, an operator may walk around space 102 with data capture device 108 to enable the data capture operation. As data capture device 108 captures data representing space 102, data capture device 108 may send the captured data to server 104 for processing, and more specifically, for the identification of objects or hazards in space 102.

In some examples, server 104 may obtain the captured data representing space 102 in real-time, as data capture device 108 captures the data. In other examples, server 104 may obtain the captured data representing space 102 after data capture device 108 completes a data capture operation (e.g., after completion of a scan of space 102).

At block 210, server 104 extracts, from the captured data obtained at block 205, an image from the captured data. In some examples, the image may be a still image explicitly captured by data capture device 108, and accordingly said image may be used to identify hazards in space 102. In other examples, server 104 may select one or more frames from video data captured by data capture device 108 to be used as the image(s) in which to identify hazards in space 102. In some examples, the video frames may be preprocessed and analyzed to select a representative video frame, and in particular a frame with good clarity, contrast, lighting, and other image parameters. In other examples, the video frame extracted to be used as the image may be selected at random.

At block 215, server 104 feeds the image extracted at block 210 to object detection engine 128 to determine whether any recognized objects or hazards are detected in the image. As with obtention of the captured data, server 104 may similarly feed the image extracted at block 210 to object detection engine 128 in real-time, as the captured data is received and the images are extracted, for real-time identification of hazards and/or objects of interest. In other examples, server 104 may feed the extracted image to object detection engine 128 in non-real-time, for example, after completion of a scan of space 102 during a post-capture analysis operation.

In some examples, server 104 may feed all or substantially all video frames to object detection engine 128 to allow object detection engine 128 to provide a filter to the frames to be further analyzed. That is, object detection engine 128 may be configured to proceed to block 220 to return an annotated image to server 104 only if a hazard or object of interest is detected. Images or video frames in which no hazards or objects of interest are detected may be discarded or otherwise removed from further processing by server 104.

At block 220, server 104 obtains, from object detection engine 128, an annotated version of the image submitted at block 215. In particular, the annotated image includes an indication of a hazard or object of interest and a location of the hazard within the image. For example, the hazard may be represented by a bounding box overlaid on the image together with a label of the type of hazard (i.e., object detection). In other examples, the hazard may be represented by an arbitrarily-shaped outline of the location of the object on the image (i.e., segmentation).

In some examples, method 200 may proceed from block 205 directly to block 220, for example when the data captured at block 205 includes a user-provided annotation indicating the location of a hazard or object of interest.

At block 225, server 104 converts the location of the object as identified by object detection engine 128 and received at block 220, to a 3D location of the object within space 102. In particular, server 104 may further base the conversion on a source location of data capture device 108 during capture of the image in which the hazard or object was detected, and a 3D representation of the space, such as representation 124.

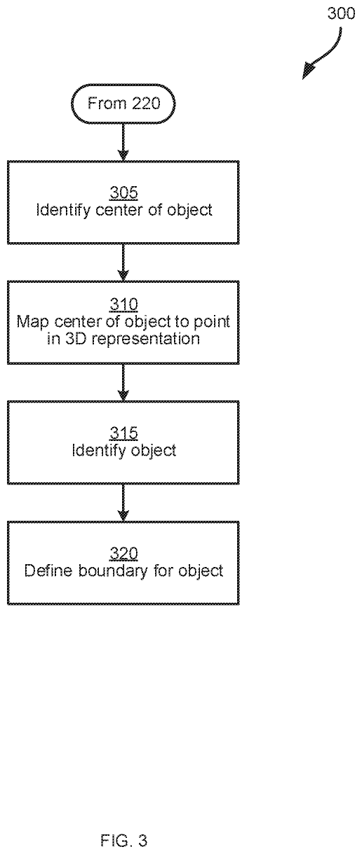

For example, referring to FIG. 3, an example method 300 of converting a location of an object in an image to a 3D location of the object within a 3D representation of a space is depicted.

Method 300 is initiated at block 305, for example in response to receiving the annotated image at block 220 including an indication of the location of the object within the image. Accordingly, at block 305, server 104 identifies a center of the object. For example, when the location of the object is indicated with a bounding box overlaid on the image, the center of the object may be identified as the center of the bounding box. This may include suitable approximations of the centers of irregular shapes, if for example, the bounding box is not rectangular. If the location of the object is indicated with a single point, then server 104 may identify said point as the center of the object. Other suitable identifications of the center of the object based on the provided location of the object are also contemplated.

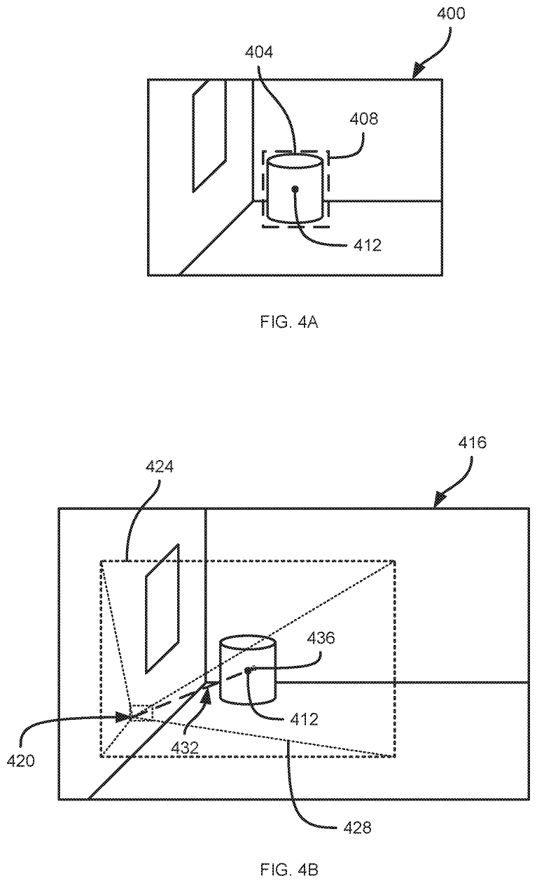

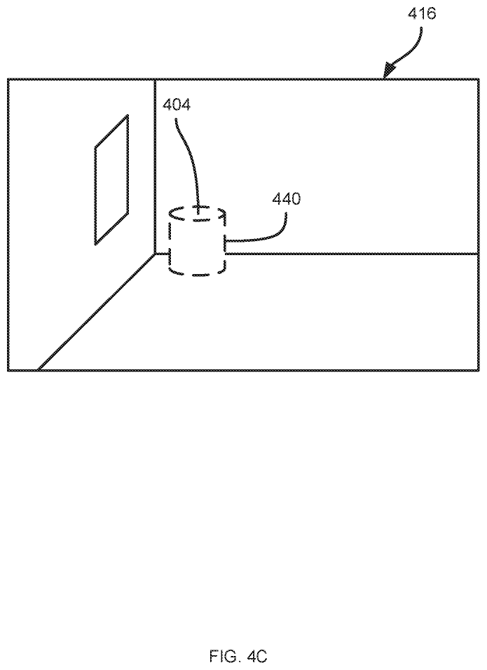

For example, referring to FIG. 4A, an example image 400 is depicted. The image 400 includes a barrel 404 which may be recognized as a hazard and/or object of interest by object recognition engine 128. Accordingly, at block 220 of method 200, object recognition engine 128 may return the image 400 together with a bounding box 408 surrounding the barrel 404. At block 305 of method 300, server 104 may identify a point 412 as the center of bounding box 408.

Returning to FIG. 3, at block 310, server 104 maps the center of the object identified at block 305 to a 3D point in the 3D representation. In particular, server 104 may perform the mapping based on a source location of data capture device 108 during capture of the image. Server 104 may additionally use the persistent spatial information defined in representation 124 to map the 3D location of the object.

In particular, during the data capture operation (e.g., during or prior to execution of block 205), data capture device 108 may localize itself with respect to space 102. Accordingly, as the data capture operation takes place, data capture device 108 may track its location within space 102 (e.g., based on local inertial measurement units (IMUs), based on the captured image and depth data and a comparison to the persistent spatial information captured in representation 124, or similar). At block 210 then, when the image is extracted for identification of an object, a source location of data capture device 108 during capture of the extracted image may also be identified. This source location may be stored in association with said image, and the resulting annotated image after receipt of the annotated image at block 220.

For example, referring to FIG. 4B, a partial representation 416 of space 102 is depicted. In particular, the partial representation 416 is a 3D representation and includes a representation of the barrel 404 in 3D space. Server 104 may identify a source location 420 of data capture device 108 during capture of the image 400. In particular, the source location 420 may be represented by the frustum of a pyramid 428 representing the capture information for the image 400.

To map the point 412 to 3D space within the partial representation 416, server 104 may define a ray 432 from the source location 420 to the point 412 on a plan 424. Server 104 may define a point 436 as the point of intersection of the ray 432 and the partial representation 416. That is, server 104 may apply a ray casting method from the source location 420 through the point 412, for example using a projection matrix, to obtain the projected point 436. More generally, the point 436 may be represented by the nearest object to the source location 420 along the ray 432. In the present example, the point 436 lies on the barrel 404. The point 436 and its 3D location within representation 124 therefore represents the mapped 3D location of the center of the object identified by object recognition engine 128.

Returning again to FIG. 3, after mapping the center of the object identified at block 305 to a point in the 3D representation at block 310, method 300 proceeds to block 315. At block 315, server 104 identifies the object within the 3D representation. For example, server 104 may employ a clustering algorithm on the point cloud representing space 102 with the 3D point representing the center of the object as the seed to identify a subset of points of the point cloud representing the object. Other methods of identifying a subset of points within the 3D representation which represent the object are also contemplated.

At block 320, server 104 may define a boundary for the object. In some examples, the boundary of the object may be the edges and/or surfaces of the object itself. In other examples, the boundary of the object may be a 3D bounding box or the like encompassing all of the points of the object. For example, the 3D bounding box may be the smallest rectangular prism encompassing all of the points of the object. The boundary defined at block 320 may be used to represent the object in 3D representations of space 102.

For example, referring to FIG. 4C, an example boundary 440 of barrel 404 is defined in the partial representation 416. In the present example, boundary 440 is defined by the edges and surfaces of barrel 404 itself, since barrel 404 is a well-defined object.

In other examples, other variations and methods of converting a location of an object as represented in an image to a 3D location in a 3D representation, given the source location of the data capture device at which the image was captured, are also contemplated. For example, rather than basing the location of the object in the 3D representation on the center of the object, server 104 may cross-correlate other images including the object to define the boundary of the object. That is, server 104 may define, for each of a plurality of images, rays from the source location of the image to the bounding box defined in the image. The intersection of the sets of rays from the plurality of images may define the boundary of the object.

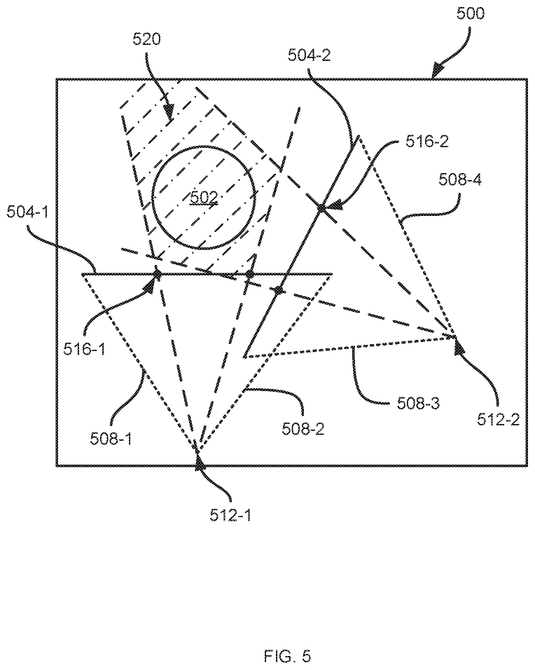

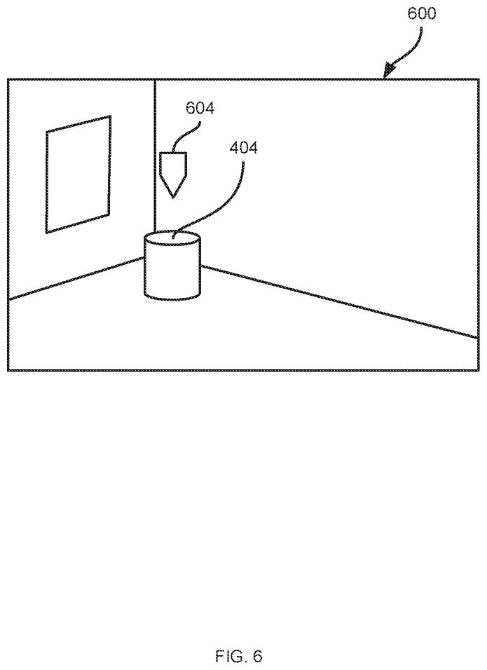

For example, referring to FIG. 5, a top view of a representation 500 is depicted. The representation 500 includes an object 502 of interest. Server 104 may define for two images containing object 502 having image planes 504-1 and 504-2, rays 508-1, 508-2, 508-3, and 508-4. In particular, rays 508-1 and 508-2 extend from a first source location 512-1 through edges of a bounding box 516-1 about object 502 on the image plane 504-1. Similarly, rays 508-3 and 508-4 extend from a second source location 512-2 through edges of a bounding box 516-2 about object 502 on the image plane 504-2. The intersection 520 of the regions defined between rays 508-1 and 508-2 and rays 508-3 and 508-4, respectively may be defined as the 3D location of object 502. As will be appreciated, with more images of object 502 from different angles, the intersection 520 may be narrowed to more accurately represent the 3D location of object 502.

In other examples, the object may be defined based on common points of the point cloud contained within each cone defined by the rays from the source location to the boundary of each image of a plurality of images. In still further examples, rather than defining a ray from the source location to a feature identified on the capture plane, server 104 may use depth data corresponding to the image data and the source location to identify the 3D location of the object of interest. Upon completion of the conversion of the location of a hazard or object of interest to its 3D location in the 3D representation, method 200 proceeds to block 230.

At block 230, server 104 updates representation 124 of space 102 to an include an indication of the hazard or object of interest. For example, representation 124 may be updated to include an annotation identifying the 3D location identified at block 225. The annotation may be the boundary or bounding box defining the 3D location of the object. In other examples, the annotation may be a marker located a predefined distance above or adjacent to the 3D location of the object, for example pointing to or otherwise highlighting the 3D location of the object in the representation 124.

In some examples, at block 230, server 104 may further push the updated representation 124 of space 102 to client device 112 and/or data capture device 108 for display to a user. For example, in particular when method 200 is performed in real-time during a scan or data capture operation by data capture device 108, the indication defined at block 230 may be displayed at data capture device 108 as an overlay on a current capture view (i.e., a view of portion of space 102 currently being captured) when server 104 identifies a hazard or object of interest in the current capture view.

For example, referring to FIG. 6, an example current capture view 600 of data capture device 108 is depicted. In particular, current capture view 600 may be similar but angled differently to image 400, processed in real-time by server 104 to identify barrel 404 as a hazard. Accordingly, upon identifying barrel 404 as a hazard, data capture device 108 may receive an update from server 104 to additionally display a marker 604 at a predefined location above barrel 404. In particular, the marker 604 may have its location defined in 3D space, and hence even though current capture view 600 may be at a different angle and/or distance from barrel 404, based on the localization and spatial tracking of data capture device 108 relative to space 102, marker 604 may be maintained at the predefined location above barrel 404 when barrel 404 is in current capture view 600.

Additionally, in some examples, server 104 may receive feedback from the user operating client device 112 and/or data capture device 108. For example, rather than passively presenting the hazard or object to the user at client device 112, the identified hazard or object may be presented with an option for confirmation. Accordingly, the user of client device 112 may provide a confirmatory or negative response that the hazard is in fact a hazard and/or that the hazard is identified correctly. In some examples, upon receiving the response from the user via client device 112, server 104 may provide feedback to object detection engine 128 to feed its machine learning-based algorithm.

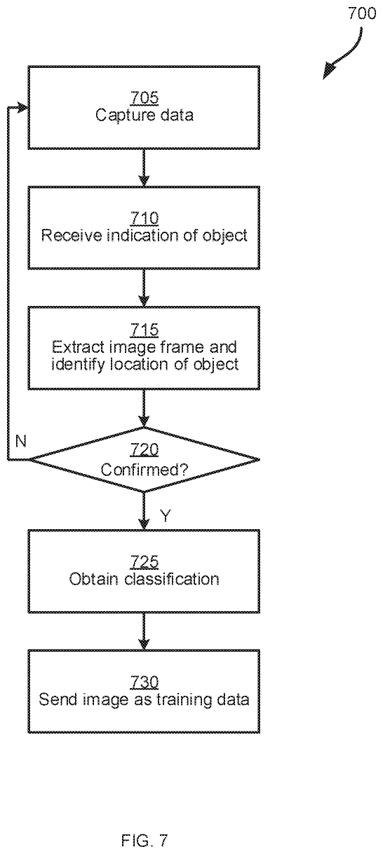

Further, as described above, training of object detection engine 128 to recognize hazards and/or objects of interest occurs prior to the performance of method 200 to identify hazards in space 102. In other examples, training of object detection engine 128 may also occur in real time, for example, as a user is performing a data capture operation using data capture device 108. For example, referring to FIG. 7, an example method 700 of generating training data for training object detection engine 128 to recognize hazards and/or objects of interest is depicted. Method 700 is described below in conjunction with its performance by data capture device 108; in other examples, some or all of method 700 may be performed by other suitable devices, such as client device 112.

At block 705, a data capture operation is ongoing. That is, the user may be operating data capture device 108 and moving about space 102 to capture data.

At block 710, during the data capture operation, the user may notice a hazard or object of interest and may provide an input to data capture device 108 indicating the presence of a hazard or object of interest.

At block 715, data capture device 108 extracts the image (e.g., a video frame) in which the indication was provided and identifies a location within the image of the object (i.e., a 2D location). In particular, data capture device 108 may identify a bounding box or boundary (e.g., including an irregularly shaped boundary) for the object. For example, to select the object, the user may tap on the object. Data capture device 108 may then perform one or more image processing algorithms to identify the object that the user tapped on (i.e., based on a single point of input) and define a bounding box or boundary for it.

In other examples, to select the object, the user may draw a bounding box around the object using an input device (e.g., stylus, touchscreen display, mouse and pointer, etc.) of the data capture device 108. The bounding box (or irregularly shaped boundary) provided by the user may then be used as the location of the image.

At block 720, data capture device 108 may optionally provide an opportunity for the user to confirm the selection of the object. For example, data capture device 108 may present the image frame together with the selected bounding box or boundary of the object.

If at block 720, the user rejects the selection of the object, then method 700 returns to block 705 to continue the data capture operation.

If at block 720, the user confirms the selection of the object, then method 700 proceeds to block 725. At block 725, data capture device 108 may request and receive from the user, a classification (e.g., a label or a tag) for the selected object. For example, the label may be a type of hazard or object of interest under which the object should be classified for future learning. Data capture device 108 may present a predefined list of classifications from which the user may select one or more. In some examples, data capture device 108 may allow for free text input from the user.

At block 730, data capture device 108 submits the image including the location of the object to object detection engine 128 as training data. That is, object detection data 128 may use the image, the location of the object, and the object's classification as one of its sets of training to recognize other objects with the object's classification.

The scope of the claims should not be limited by the embodiments set forth in the above examples but should be given the broadest interpretation consistent with the description as a whole.

1. A method comprising:
obtaining, from an object detection engine trained to recognize a plurality of objects, an image representing a space and including an object of interest located in the space and a location of the object of interest within the image;
converting, based on the location of the object within the image, a source location of an image capture device which captured the image and a three-dimensional representation, the location of the object to a three-dimensional location of the object within the three-dimensional representation of the space; and
updating the three-dimensional representation of the space to include an indication of the three-dimensional location of the object of interest.

2. The method of claim 1, further comprising:
obtaining captured data representing the space;
extracting the image from the captured data; and
feeding the image to the object detection engine to recognize the object of interest and identify the location of the object of interest.

3. The method of claim 2, wherein extracting the image comprises selecting a representative video frame from video data.

4. The method of claim 1, wherein the location of the object is represented by a bounding box about the object.

5. The method of claim 4, wherein converting the location of the object to the three-dimensional location comprises:
identifying a center of the bounding box;
mapping the center to a point in the three-dimensional representation;
identifying the object within the three-dimensional representation; and
defining a boundary for the object within the three-dimensional representation, the boundary representing the three-dimensional location of the object.

6. The method of claim 5, wherein mapping the center to a point in the three-dimensional representation comprises:
identifying source location of the image capture device during capture of the image in the three-dimensional representation;
identifying a capture plane of the image in the three-dimensional representation;
defining a ray from the source location through the center of the bounding box, which lies on the capture plane; and
defining the mapped point in the three-dimensional representation as a point of intersection of the ray and the three-dimensional representation.

7. The method of claim 1, wherein converting the location of the object to the three-dimensional location comprises cross-correlating the image to one or more further images including the object to define a boundary of the object.

8. The method of claim 1, wherein the indication of the three-dimensional location of the object comprises a marker located a predefined distance above the three-dimensional location of the object.

9. The method of claim 1, wherein the obtaining, converting, and updating occurs in real-time, and further comprising presenting the indication of the three-dimensional location of the object as an overlay in a current capture view of a data capture device.

10. The method of claim 1, further comprising, during a data capture operation at a data capture device:
receiving an indication of a further object of interest;
extracting a further image representing a current capture view of the data capture device at a time of the receiving the indication;
identifying a further location within the further image of the further object of interest; and
sending the further image with the further location of the further object of interest to the object detection engine for training.

11. The method of claim 10, wherein receiving the indication comprises receiving a single point of input, and wherein identifying the further location comprises applying one or more image processing algorithms based on the single point of input.

12. The method of claim 10, wherein receiving the indication comprises receiving a boundary about the further object of interest.

13. The method of claim 10, further comprising presenting the further image with the further location of the further object of interest at the data capture device for confirmation.

14. A server comprising:
a memory storing a three-dimensional representation of a space;
a communications interface; and
a processor interconnected with the memory and the communications interface, the processor configured to:
obtain, from an object detection engine trained to recognize a plurality of objects, an image representing the space and including an object of interest located in the space and a location of the object of interest within the image;
convert, based on the location of the object within the image, a source location of an image capture device which captured the image and the three-dimensional representation, the location of the object to a three-dimensional location of the object within the three-dimensional representation of the space; and
update the three-dimensional representation of the space to include an indication of the three-dimensional location of the object of interest.

15. The server of claim 14, wherein the object detection engine is implemented by the server.

16. The server of claim 15, wherein the object detection engine employs one or more neural networks, machine learning, or artificial intelligence algorithms.
